(19) United States
(12) Patent Application Publication
(10) Pub. No.: US 2016/0319080 A1
(43) Pub. Date: Nov. 3, 2016

(54) ELASTOMERS WITH EXCEPTIONAL ELONGATION

(71) Applicant: Gelest Technologies, Inc., Morrisville, PA (US)

(72) Inventors: Barry C. ARKLES, Pipersville, PA (US); Jonathan D. GOFF, Philadelphia, PA (US)

(21) Appl. No.: 15/133,992

(22) Filed: Apr. 20, 2016

Related U.S. Application Data
(60) Provisional application No. 62/153,824, filed on Apr. 28, 2015.

(51) Int. Cl. C08G 77/38; C08K 3/36

(52) U.S. Cl. CPC C08G 77/38; C08K 3/36

(57) ABSTRACT

Nanocomposites exhibiting elongation exceeding about 2000%, elastic recovery, and tensile strength exceeding 2.5 MPa are described. A method these elastomers involves performing a catalyzed step growth polymerization of a heterobifunctional siloxane macromonomer compounded with at least about 15 wt % surface passivated silica nanoparticles. The macromonomer has a degree of polymerization of at least about 40 and the silica nanoparticles have nominal diameters of less than about 50 nm.

### CROSS-REFERENCE TO RELATED APPLICATION

This application claims priority to U.S. Provisional Patent Application No. 62/153,824, filed Apr. 28, 2015, the disclosure of which is herein incorporated by reference.

### BACKGROUND OF THE INVENTION

Interest in elastomers with elongations exceeding 1000% has been generated by medical applications for deliverable, highly-deformable devices ranging from intraocular lenses and flexible duct stents to in-vivo microfluidic diagnostics and drug delivery. Common elastomeric materials are exemplified by natural rubber with elongations commonly reported in the range of 500-800% and by muscular hydrostats with elongations reported in the range of 100-200%. Synthetic elastomers with covalent crosslinking typically have elongations of less than 800%.

Most siloxane polymers are prepared by equilibrium ring-opening polymerization (ROP), which results in polymers with broad molecular weight distributions (Polydispersivity Index (PDI) >2.5), and curtails their ability to act as precise structural elements. Until now, elastomeric behavior in silicones has been induced by crosslinking polymers produced by equilibration utilizing a variety of techniques. Earlier work on dendrimers has revealed a low efficiency in generational growth based on hydrosilylation of structural elements containing silicon-hydride (Si—H) and silicon-vinyl (Si—CH₂═CH₂) terminations. In general, the lack of efficiency can be attributed to stoichiometric imbalance at the reactive centers due to steric interference, phase separation, or divergent reaction pathways. The most obvious divergent reaction in this system is cyclization. While cyclization reactions are known in general for polymer systems, in siloxane systems they have been studied only under equilibrium ROP conditions.

A living polymerization that results in heterobifunctional macromonomers of intermediate molecular weight, which in a second distinct step-growth polymerization are converted to elastomers with high molecular weight, have been previously described in U.S. Pat. No. 8,952,118 and U.S. Pat. No. 9,145,474. These homogenous elastomers have elongations of approximately 2000% or less, with low mechanical strength. No cross-linking has been detected and elastomeric behavior is observed at temperatures higher than both the Tg and Tm of the polymer, suggesting that topological features rather than covalent bonding or domain formation are operative.

### BRIEF SUMMARY OF THE INVENTION

A polysiloxane nanocomposite elastomer according to an embodiment of the invention exhibits an elongation exceeding 2000% and a tensile strength exceeding 2.5 MPa.

In a further embodiment, the invention is directed to a method for forming a nanocomposite elastomer exhibiting an elongation exceeding 2000% and a tensile strength exceeding 2.5 MPa which comprises performing a catalyzed step growth polymerization of a heterobifunctional siloxane macromonomer compounded with at least about 15 wt % surface passivated silica nanoparticles to form the nanocomposite elastomer, wherein the macromonomer has a degree of polymerization of at least about 40 and the silica nanoparticles have nominal diameters of less than about 50 nm.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a graph of representative molecular weights of monodisperse heterobifunctional polysiloxane macromonomers according to an embodiment of the invention;

FIGS. 2A, 2B, and 2C are gradient suppression NMR spectra of macromonomers according to embodiments of the invention;

FIG. 3 is a chart summarizing mechanical properties of elastomers according to embodiments of the invention and comparative materials based on Instron measurements; and

FIG. 4 is a graph of stress-strain curves for nanocomposites according to an embodiment of the invention.

### DETAILED DESCRIPTION OF THE INVENTION

The invention is directed, in part, to polysiloxane nanocomposite elastomers which exhibit elongations exceeding 2000% and tensile strengths exceeding 2.5 MPa. The elastomers according to the invention return to their original dimensions ±30% after distortion within 75% of the failure limit It has unexpectedly been found that siloxane elastomers with exceptional elongation are formed from heterobifunctional silicone macromonomers with degree of polymerization (DP) of at least about 40 compounded with a minimum of about 15 wt % surface passivated silica nanoparticles as reinforcement. Nanocomposites, such as those having a M_{w} of at least about 1,000,000, having elastomer elongation and elastic recovery, are directly formed via step-growth polymerization catalyzed with a maximum of 100 ppm Pt.

More specifically, the nanocomposites according to the invention are generated from mixtures of silica nanoparticles compounded into very high molecular weight silicone macromonomers (also referred to herein as silicone macromers or siloxane polymers). The elastomers have Mn greater than about 100,000, preferably >1,000,000, and Mw greater than 1,000,000, preferably >10,000,000, and free of any low molecular weight species <1500. These nanocomposites exhibit exceptional elastomeric behavior: elongations exceeding 2000% with elastic recovery of greater than 90% when extended to 80% of ultimate elongation. The catalyzed step-growth polymerization allows the formation of highly knotted polymers. Thus, the formation of knots, observed indirectly by NMR swelling studies, is another essential feature for the formation of these high elongation elastomers. The elastomers are preferably free of any observable covalent crosslinking at the 2 ppm detection limit, such as determined by gradient suppression NMR of the swollen elastomers.

The silica is preferably in the form of surface passivated nanoparticles with nominal diameters of less than about 50 nm. The preferred passivation is a surface treatment with hexamethyldisilazane, but passivation with other treatments such as octamethylcyclotetrasiloxane or dimethylaminotrimethylsilane would also be appropriate, as would any method that deactivates the majority of Si—OH groups on the surface of the silica. Silica nanoparticle loadings between about 15 and 45 weight % compounded in the heterobifunctional macromonomer are preferred; loadings of 30-35 weight % are most preferred. Methods of compounding are well known in the art and need not be described; appropriate devices for compounding include, without limitation, planetary mixers, sigma-blade mixers, twin-screw extruders, and dual asymmetric centrifugal mixers.

The heterobifunctional silicone macromonomers according to the invention preferably have number average molecular weights (Mn) ranging from 3,000-30,000 g mol' and a PDI near unity.

The siloxane backbone may be, for example, a dialkylsiloxane such as dimethylsiloxane, ethylmethylsiloxane, diethylsiloxane, dimethylsilylethylsiloxane, or trifluoropropylmethylsiloxane, or an aromatic-substituted siloxane such as diphenylsiloxane or phenylmethylsiloxane. Preferably, the siloxane backbone is dimethylsiloxane.

The polymerization catalyst is preferably a Pt° catalyst, such as the preferred Karstedt's catalyst which is well known in the art. However, other hydrosilylation or appropriate catalysts known in the art or to be developed would also be within the scope of the invention. Preferably, the platinum is present in an amount of no more than about 100 ppm on a weight basis.

In preferred embodiments, the macromonomers contain a vinyl group and a hydride group at the opposite ends of the siloxane, which must be in a substantially 1:1 stoichiometric ratio (as demonstrated, for example, by NMR). The vinyl and hydride groups will react with each other in a hydrosilylation reaction. Other heterobifunctional monomers within the scope of the invention include vinyl and mercaptan functionality, hydride and silanol functionality, or hydrogen and alkoxy functionality. These heterobifunctional macromonomers may be coupled by a thiolene reaction, dehydrogenative coupling, de-alkylative coupling, or azido-acetylenic click-chemistry. With a precise 1:1 stoichiometric ratio of complimentary functionalities inherent on each polymer chain, the high purity heterobifunctional macromonomer fits the ideal model for an A-B step-growth linear polymerization. In the presence of a catalyst, such as the preferred platinum, the vinyl and hydride end groups will undergo a high efficiency intermolecular hydrosilylation reaction and the macromonomer will reach an extremely high degree of polymerization. Thus, when practiced experimentally for a series of heterobifunctional macromers, the step-growth polymerization in the presence of nano-particles unexpectedly yields elastomeric bodies, despite the lack of an obvious crosslinking mechanism during the linear polymerization.

In order to better understand the limitations of efficient formation of higher order siloxanes by hydrosilylation, heterobifunctional macromonomers with Si—H and Si—CH₂═CH₂ at opposite ends of the polymer chain were studied. In previous work, linear polymerization of low molecular weight heterobifunctional macromonomers produced by hydrolytic condensation using a hydrosilylation reaction achieved only low molecular polymers. However, it has been found that, after developing a new synthesis for heterobifunctional macromonomers, the inability to achieve high molecular weight polymers in earlier work was a consequence of the inability to generate high purity macromonomers of sufficiently high degree of polymerization which avoided divergent chain-termination and cyclization reactions. Living anionic ring opening polymerization (AROP) of siloxanes has been reported in the development of well-defined monofunctional siloxane macromonomers, utilized for example in contact lenses where they satisfy mechanical properties, hydration and oxygen permeability requirements for corneal tissue. Living AROP has been further advanced to allow access to heterobifunctional siloxane macromonomer structures with tunable functionalities that are unachievable by equilibrium and hydrolytic polymerizations. These heterobifunctional macromonomers are of high purity and sufficient molecular weight with precise stoichiometric balance between reactive end groups.

The invention also relates to a method for producing the inventive nanocomposite elastomers exhibiting elongation exceeding 2000%, elastic recovery, and tensile strength exceeding 2.5 MPa. The method comprises catalyzed step grown polymerization of a heterobifunctional silicone macromonomer compounded with at least about 15 wt % surface passivated silica nanoparticles with nominal diameters of less than about 50 nm to form the elastomeric nanocomposite, which may have a molecular weight Mw of at least about 1,000,000. Using such a method, the resulting nanocomposite elastomers exhibit no apparent covalent crosslinking to a detection level of 2 ppm. Silica nanoparticle loadings between about 15 and 45 weight %, more preferably about 30 wt %, compounded in the heterobifunctional macromonomer, are preferred.

Preferably, the polymerization is catalyzed with platinum, preferably at a maximum concentration of about 100 ppm on a weight basis. The polymerization catalyst is preferably a Pt° catalyst, such as the preferred Karstedt's catalyst. However, other hydrosilylation or appropriate catalysts known in the art or to be developed would also be within the scope of the invention.

The siloxane backbone may be, for example, a dialkylsiloxane such as dimethylsiloxane, ethylmethylsiloxane, diethyl siloxane, dimethylsilylethylsiloxane, or trifluoropropylmethylsiloxane, or an aromatic-substituted siloxane such as diphenylsiloxane or phenylmethylsiloxane. Preferably, the siloxane backbone is dimethylsiloxane.

Preferably, the hetetrobifunctional silicone macromonomer contains hydride and vinyl termini, as previously described. However, this method of preparing the inventive nanocomposite elastomers from hydrosilylation is not limiting, and analogous heterobifunctional macromonomer systems may be possible using complementary functionalities which employ, for example a thiolene reaction, dehydrogenative coupling, de-alkylative coupling, or azido-acetylenic click-chemistry.

As previously explained, the siloxane polymers according to the invention have very high molecular weights. However, direct methods of molecular weight determination are not effective for such materials. To investigate the minimum molecular weight requirements for elastomer behavior of these polymers, a monofunctional reagent, vinylpentamethyldisiloxane, was added in different concentrations to the macromonomer polymerization to create a stoichiometric imbalance of reactive groups. This at once allowed for molecular weight control in linear A-B step growth polymerizations and provided a basis for estimating the molecular weight at high conversions of macromonomer. The degree of polymerization, Dₚ is described by the Carother's equation:

$${D}_{p} = \frac{1}{( 1 - p )} ,$$

where p is the extent of conversion of endgroups. The stoichiometric ratio of end groups is defined as

$$r = \frac{{N}_{PDMShydride}}{{N}_{PDMSvinyl} + 2 {N}_{vinylpentamethyldisiloxane }}$$

for A-B step growth monomers. At p values near 100%

$${D}_{p} = \frac{( 1 + r )}{( 1 - r )}$$

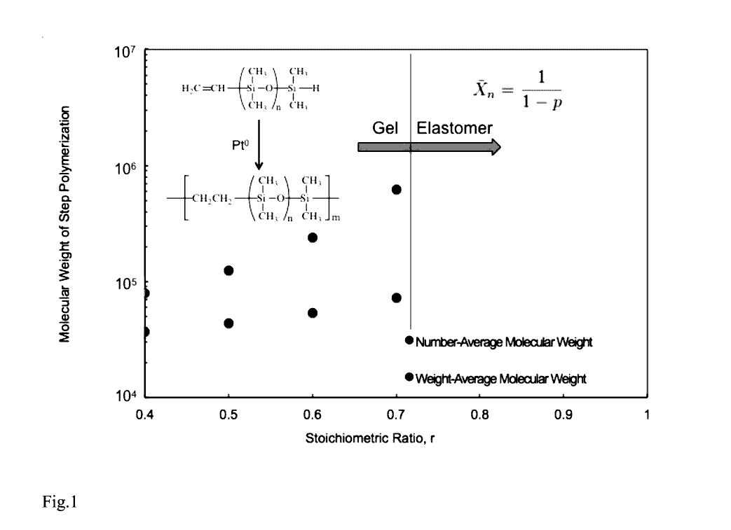

which allows tor specific molecular weights to be targeted. At an r value of 0.7 for a 15,000 dalton macromonomer, a crossover between a high molecular weight gel and an elastomer occurred. GPC Mₙ and M_{w} characterization of polymers with stoichiometric ratios approaching the crossover point show polydisperse materials with high molecular weight fractions exceeding 1,000,000, as shown in FIG. 1. Polymers above the cross-over point swell in solvent and cannot be characterized by GPC.

As shown in FIG. 1, the molecular weight of a 15,000 dalton macromonomer step-growth polymerization product was measured directly by GPC up to the elastomeric behavior crossover point, showing the dependency on end group stoichiometry. Polymer Dₚ at end group stoichiometric ratios approaching the crossover point correlates closely with the theoretical Dₚ polymer values calculated from the modified Carothers equation:

$${D}_{p} = \frac{( 1 + r )}{( 1 - r )} .$$

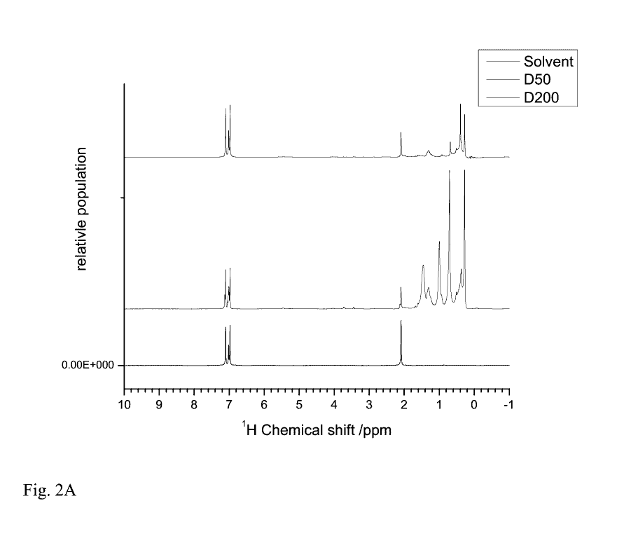

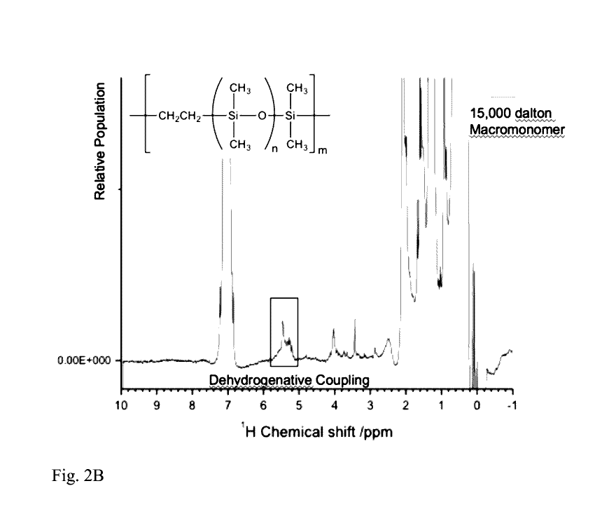

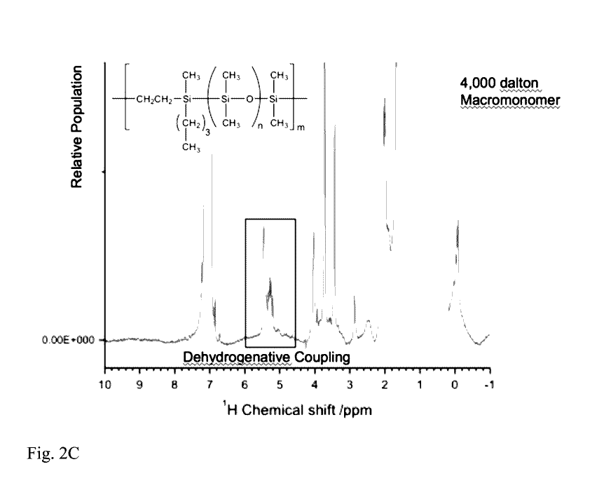

As anticipated, cold-crystallization exotherms associated with traditional polysiloxanes were not appropriate for estimating step-growth polymer molecular weight or M_{c}, since the ethylene bridges formed during step-growth polymerization resulted in segmental isolation and in fact narrowed the temperature range of the thermal transitions. Using gradient suppression NMR techniques on r=1.0 polymers swollen in d8-toluene (FIGS. 2A, 2B, and 2C), no evidence of covalent crosslinking was observed; complete conversion of starting macromonomer end groups to the limit of detection (2 ppm) is seen. Evidence of trace amounts of ethenyl linkages between silicon atoms formed from the dehydrogenative coupling of end groups was observed. The dehydrogenative coupling mechanism is also a chain-extending process analogous to the principal hydrosilylation pathway in the step-growth polymerization. It may be estimated from the spectrum that the p for the A-B step growth monomer is >0.995, and the number average molecular weight of the polymer was extrapolated to be at least 3,000,000 daltons for the 15,000 dalton macromonomer.

The gradient suppression NMR in d8-toluene in FIG. 2A showed no indication of crosslinking. A small fraction of ethenyl linkages (mole %) between siloxane segments resulting from dehydrogenative coupling of macromonomer end groups was observed between 5-6 ppm on the spectra. No residual starting endgroups (vinylsilane: 6 ppm; hydride: 4.5 ppm) of the macromonomer remained after polymerization to the limit of detection of the gradient suppression NMR technique (2 ppm or 2×10⁻⁴ mole %). A butyl tag was added to the 4,000 dalton macromonomer vinylsilane end group (FIG. 2c) for quantitative determination of the amount of ethenyl linkages present in the elastomeric polymer (1 mol%).

Mechanical testing revealed that the homogeneous elastomeric polymer systems have high elongations, depending on macromonomer molecular weight, in the range of 500-2500%, and tensile strengths characteristic of silicone elastomers (0.2-0.3 MPa). To improve the strength, surface-passivated silica nanoparticles were compounded into the macromonomers to loadings of 30wt % followed by the platinum catalyzed step-growth polymerization. The nanocomposites formed have increased tensile strengths, in the range of 10 MPa, and unprecedented elastic elongations, exceeding 5000% as macromonomer molecular weight increases to 15,000 daltons or greater. These nanocomposites exceed the highest reported elongations of any elastomeric materials.

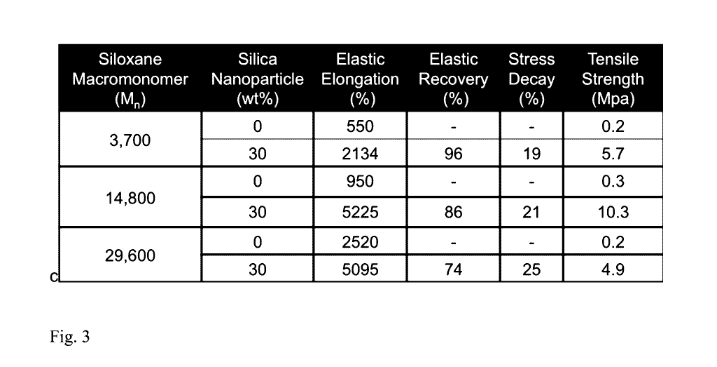

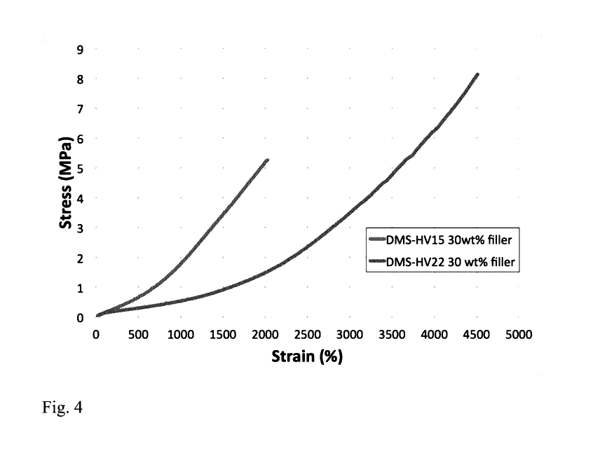

FIG. 3 summarizes the mechanical properties of elastomers according to the invention based on Instron measurements, as well as the properties of the macromonomers from which they were prepared. It can be seen that the unfilled macromonomer systems yielded low strength polymers with elongations on the upper end of reported values for elastomeric materials. When the macromonomers were reinforced by compounding with silica nanoparticles, the resulting nanocomposites displayed unprecedented elongations. Elastic recovery was measured by comparing the change in specimen length after stretching the nanocomposites to 80% of their elongation at break for 10 minutes. Stress decay was determined by observing the change in stress after 1 minute of stretching the nanocomposites to 80% of their elongation at break. FIG. 4 shows the stress-strain curves for nanocomposites according to the invention.

While a number of topological models can account for the high elongation of these uncrosslinked polymer systems, there appear to be none that can satisfactorily account for the recovery to original dimensions. There is a lively debate in the field surrounding the role of knotting and entanglement on the non-linear behavior of polymers. Computational studies on knotting in polymers as well as entanglement measurements suggest that the behavior of these high molecular weight polymers must consider these phenomena. In NMR heptane swelling studies of the elastomers according to the invention, the narrowing of bandwidth that is normally observed with polymer dilution (or swelling) does not occur. Without wishing to be bound by theory, this suggests that there are localized regions of consistent interactions within a polymer chain at all concentrations and similarly at all elongations. Further, swelling experiments for the elastomers according to the invention have calculated molecular weights between virtual restriction points of ˜40,000 daltons, exceeding the molecular weight of entanglement (Mₑ) of 12,000-29,000 daltons reported for polysiloxanes. These results appear consistent with knot formation rather than chain entanglement. It is also noteworthy that a previous report of a relatively high elongation polysiloxane system was crosslinked in a solvent, reducing the opportunity for chain entanglement.

Computational modeling experiments were undertaken to determine the configuration which a segment of the step-growth polymer with a molecular weight of 50,000 daltons could assume at room temperature (above both Tg and Tm). The experiments revealed that, compared to most polymers, the siloxanes have a greater propensity to form random coils and to undergo intra-chain knotting. For the actual high molecular weight polymers exhibiting elastomeric behavior, there is the clear probability of multiple intra-chain knots.

It has thus been discovered that a heterobifunctional siloxane macromonomer Mₙ having a DP of at least about 40 compounded with at least about 15 wt % surface passivated silica nanoparticles, when subjected to a step-growth polymerization, yields >1,000,000 M_{w} polymer nanocomposites with exceptional elongations. These conditions are required to ensure intra- and inter-chain knotting of high molecular weight siloxanes, which is the proposed mechanism for elongation and elastic recovery. A hypothetical model is proposed which relies on both the behavior of individual knots within a polymer chain and the interaction of ensembles of knots between polymer chains and, independently, with the surfaces of nanoparticles. It is envisioned that, while entangled chains can become disentangled during extension, simple trefoil knots within a polymer chain will not be unknotted. For identical polymers with equivalent degrees of polymerization, the end-to-end chain length is necessarily less for an intra-chain knotted structure compared to an unknotted structure. The length of the extended chain of a knotted polymer is reduced mostly by the looseness of the knots. If the comparative polymer chains are extended from their ends, the apparent increase in percent extension of the knotted polymer is greater due to knot tightening. This would seem to explain why while higher elongations are achieved, failure occurs at the same stress level (tensile strength). Recovery is dictated both by intra-chain and inter-chain knot behavior. As polymer chains extend, the conformations becomes linear, while more slowly knots within the chain tighten and contract. During extension, neighboring polymer chains become more parallel, but polymer chain translation with respect to neighboring chains is limited by knot-knot interaction. When stress is relieved, the entropic recovery from extension takes place first in linear portions of the polymer chain, but the ensembles of knots interacting between chains provide a structural basis for recovery. The higher elongation in nanocomposite systems is similarly attributed to the steric interactions between the knots and the surfaces of nanoparticles, and knot ensembles approach the same length-scales as nanoparticle dimensions.

The new polysiloxane nanocomposite materials according to the invention, which are derived from high molecular weight uncrosslinked polymeric liquids compounded with passivated silica nanoparticles, are readily manufacturable and satisfy the structural requirements for long-term implantable devices with integrated fluidics and electronics in soft tissue, including highly deformable organs such as the tongue and other muscular hydrostats.

The invention will now be described in connection with the following, non-limiting examples.

### EXAMPLES

The materials described below were analyzed and characterized as follows. Properties of some of the materials below are summarized in FIG. 3.

GPC: A Viscotek GPC Max VE2001 with a TDA 301 detector equipped with a Viscotek LT5000L mixed medium organic column was used for gel permeation chromatography (GPC) analyses. GPC data were collected in THF at 35° C. Data were analyzed with a refractive index detector using a calibration made with polystyrene standards. Modulated differential scanning calorimetry (DSC) was performed using a TA Instruments Discovery DSC. Heating and cooling rates were 10° C/min over a range −150° C. to 200° C.

Mechanical properties: Tensile and elongation testing of the samples was conducted at 20-22° C. according to ASTM D-412-80 test method using dumbbell configured specimens according to ASTM D-638 Type V (width: 3.18 mm; length: 9.53 mm; thickness: 2 mm) at a crosshead speed of 500 mm/min using an Instron Universal Testing Machine model 3345.

NMR: All ¹H solution state NMR analyses were carried out using a Bruker Advance III NMR spectrometer operating at 600 MHz Larmor frequency, using a Bruker 5 mm PABBO broadband ˜¹H/D gradient probe and operating on TopSpin 3.2 software. ˜10 mg samples of the elastomeric silicones were massed into precision 5 mm Wilmad™ 600MHz tubes with 750 μl of d8-toluene, spiked with 0.03v/v TMS as a chemical shift reference. All spectra were acquired at 298 K. 1-D ¹H NMR spectra were collected with using a gradient based ‘solvent’ suppression technique, optimized to selectively suppress the methyl proton backbone signal and allow high resolution spectra of low molar content species to be collected without receiver saturation from the otherwise dominant methyl proton backbone signal. The sequence used was a modification of the WATERGATE-W5 suppression sequence; Shaped PResaturation WATER suppression by GrAdient-Tailored Excitation using optimized W5 pulse trains (SPR-W5-WATERGATE) developed by Lam and Simpson. 2040 scans were collected with a total acquisition time (aq) of ˜2 hours per sample. 4 Hz exponential line broadening was applied to the Fourier transformed data sets.

### Example 1

### Synthesis of Monovinyl, Monohydride Terminated Polydimethylsiloxane Base Polymer

A monovinyl, monohydride terminated polydimethylsiloxane with 50 repeat units was prepared as follows. Vinyldimethyllithium silanolate (0.321 mol) in hexanes (25 mL) was synthesized in situ from the reaction of methyllithium and trivinyltrimethylcyclo-trisiloxane. (For tagging experiments utilized in the suppression NMR butylvinylmethylsilanolate was substituted.) Hexamethylcyclotrisiloxane (D3) (16 g, 0.072 mol) was added to the reaction mixture, followed by the addition of DMF or THF (5 mL) to the solution as polymerization promoter. Upon ˜95% conversion of monomer, the polymer was terminated with a slight excess of dimethylchlorosilane (30 g, 0.328 mol). The solution was stirred overnight and washed three times with deionized water. The organic layer was dried with MgSO₄ and concentrated under vacuum at 80° C. Other molecular weight asymmetric heterobifunctional siloxane macromonomers were synthesized in an analogous manner by adjusting monomer to initiator ratios to control polymer chain length.

### Example 2

### Step-Growth Polymerization of Heterobifunctional 3,700 g mol⁻¹ Macromonomer

The heterobifunctional 3,700 g mol⁻¹ monovinyl, monohydride terminated PDMS macromonomer from Example 1 (DP=50; 80 g, 0.02 mol) and platinum-divinyltetramethyldisiloxane catalyst (8 drops, 0.1 g) were mixed using a FlackTek DAC 600.1 VAC programmable speedmixer at 2200 rpm for 5 min. The mixture was poured into a mold and placed into an oven set at 100° C. for 1 hour. A clear elastomeric body was recovered. The homogeneous elastomer had an elongation at break of 550% and an ultimate tensile strength of 0.2 MPa.

### Example 3

### Step-Growth Polymerization of Heterobifunctional 14,800 g mol⁻¹Macromonomer

A heterobifunctional 14,800 g mol⁻¹ monovinyl, monohydride terminated PDMS macromonomer (DP=200; 80 g, 0.005 mol) and platinum-divinyltetramethyldisiloxane catalyst (8 drops, 0.1 g) were mixed using a FlackTek DAC 600.1 VAC programmable speedmixer at 2200 rpm for 5 min. The mixture was poured into a mold and placed into an oven set at 100° C. for 1 hour. A clear elastomeric body was recovered. The homogeneous elastomer had an elongation at break of 950% and a ultimate tensile strength of 0.3 MPa.

### Example 4

### Step-Growth Polymerization of Heterobifunctional 29,600 g mol⁻¹ Macromonomer

A heterobifunctional 29,600 g mol⁻¹ monovinyl, monohydride terminated PDMS macromonomer (DP=400; 80 g, 0.003 mol) and platinum-divinyltetramethyldisiloxane catalyst (8 drops, 0.1 g) were mixed using a FlackTek DAC 600.1 VAC programmable speedmixer at 2200 rpm for 5 min. The mixture was poured into a mold and placed into an oven set at 100° C. for 1 hour. A clear elastomeric body was recovered. The homogeneous elastomer had an elongation at break of 2520% and a ultimate tensile strength of 0.2 MPa.

### Example 5

### Elastomer Nanocomposite Formation with 2000% Elongation

30 wt % of hexamethyldisilazane treated silica nanoparticles (20 nm) and platinum-divinyltetramethyldisiloxane catalyst were compounded into a heterofunctional 3,700 g mol⁻macromonomer (as described in Example 2) using a FlackTek DAC 600.1 VAC programmable speedmixer at 2200 rpm for 5 min. The mixture was poured into a mold and heat cured in an oven at 80° C. for 1 hour. A translucent, tough elastomeric body was formed with an elongation of 2000% and a tensile strength of 5.7 MPa (FIG. 3).

### Example 6

### Elastomer Nanocomposite Formation with 4000% Elongation

20 wt % of hexamethyldisilazane treated silica nanoparticles (20 nm) and platinum-divinyltetramethyldisiloxane catalyst were compounded into a heterofunctional 14,800 g mol⁻¹ macromonomer (as described in Example 3) using a FlackTek DAC 600.1 VAC programmable speedmixer at 2200 rpm for 5 min. The mixture was poured into a mold and heat cured in an oven at 80° C. for 1 hour. A translucent, tough elastomeric body was formed with an elongation of 4000% and a tensile strength of 2.6 MPa.

### Example 7

### Elastomer Nanocomposite Formation with 4500% Elongation

25 wt % of hexamethyldisilazane treated silica nanoparticles (20 nm) and platinum-divinyltetramethyldisiloxane catalyst were compounded into a heterofunctional 14,800 g mol¹ macromonomer (as described in Example 3) using a FlackTek DAC 600.1 VAC programmable speedmixer at 2200 rpm for 5 min. The mixture was poured into a mold and heat cured in an oven at 80° C. for 1 hour. A translucent, tough elastomeric body was formed with an elongation of 4500% and a tensile strength of 5.5 MPa.

### Example 8

### Elastomer Nanocomposite Formation with 5200% Elongation

30 wt % of hexamethyldisilazane treated silica nanoparticles (20 nm) and platinum-divinyltetramethyldisiloxane catalyst were compounded into a heterofunctional 14,800 g mol¹ macromonomer (as described in Example 3) using a FlackTek DAC 600.1 VAC programmable speedmixer at 2200 rpm for 5 min. The mixture was poured into a mold and heat cured in an oven at 80° C. for 1 hour. A translucent, tough elastomeric body was formed with an elongation of 5200% and a tensile strength of 10.3 MPa.

### Example 9

### Elastomer Nanocomposite Formation with 5100% Elongation

30 wt % of hexamethyldisilazane treated silica nanoparticles (20 nm) and platinum-divinyltetramethyldisiloxane catalyst were compounded into a heterofunctional 29,600 g mol⁻¹ macromonomer (as described in Example 4) using a FlackTek DAC 600.1 VAC programmable speedmixer at 2200 rpm for 5 min. The mixture was poured into a mold and heat cured in an oven at 80° C. for 1 hour. A translucent, tough elastomeric body was formed with an elongation of 5100% and a tensile strength of 4.9 MPa.

We claim:

1. A polysiloxane nanocomposite elastomer, wherein the elastomer exhibits an elongation exceeding about 2000% and a tensile strength exceeding about 2.5 MPa.

2. The elastomer according to claim 1, wherein the elastomer is a catalyzed step growth polymerization product of a heterobifunctional silicone macromonomer compounded with at least about 15 wt % surface passivated silica nanoparticles.

3. The elastomer according to claim 2, wherein the macromonomer has a degree of polymerization of at least about 40.

4. The elastomer according to claim 2, wherein the surface passivated nanoparticles have nominal diameters of less than about 50 nm.

5. The elastomer according to claim 2, wherein the macromonomer is compounded with about 15 to 45 wt % of the silica.

6. The elastomer according to claim 1, wherein the elastomer has a molecular weight Mw of at least about 1,000,000.

7. The elastomer according to claim 1, wherein the elastomer exhibits elastic recovery.

8. The elastomer according to claim 2, wherein the macromonomer comprises hydride and vinyl termini.

9. The elastomer according to claim 1, wherein the elastomer has no apparent covalent crosslinking to a level of about 2 ppm.

10. A method for forming a nanocomposite elastomer exhibiting an elongation exceeding about 2000% and a tensile strength exceeding about 2.5 MPa, the method comprising performing a catalyzed step growth polymerization of a heterobifunctional siloxane macromonomer compounded with at least about 15 wt % surface passivated silica nanoparticles to form the nanocomposite elastomer, wherein the macromonomer has a degree of polymerization of at least about 40 and the silica nanoparticles have nominal diameters of less than about 50 nm.

11. The method according to claim 10, wherein the nanocomposite elastomer has a molecular weight Mw of at least about 1,000,000.

12. The method according to claim 10, wherein the nanocomposite elastomer has no apparent covalent crosslinking to a level of about 2 ppm.

13. The method according to claim 10, comprising performing the polymerization using a platinum catalyst.

14. The method according to claim 13, wherein the catalyst is present in an amount of no more than about 100 ppm.

15. The method according to claim 10, wherein the nanocomposite elastomer exhibits elastic recovery.

16. The method according to claim 10, wherein the macromonomer is compounded with about 15 to 45 wt % of the silica.

17. The method according to claim 10, wherein the macromonomer comprises hydride and vinyl termini.
